(19) United States
(12) Patent Application Publication
(10) Pub. No.: US 2014/0345100 A1
(43) Pub. Date: Nov. 27, 2014

(54) PIN PULLER

(71) Applicants: Hon Hai Precision Industry Co., Ltd., New Taipei (TW); Fu Tai Hua Industry (Shenzhen) Co., Ltd., Shenzhen (CN)

(72) Inventors: JIAN-MING HUANG, Shenzhen (CN); CHANG-XUE HE, Shenzhen (CN); HONG-LI GUAN, Shenzhen (CN)

(73) Assignees: Hon Hai Precision Industry Co., Ltd., New Taipei (TW); Fu Tai Hua Industry (Shenzhen) Co., Ltd., Shenzhen (CN)

(21) Appl. No.: 14/227,092

(22) Filed: Mar. 27, 2014

(30) Foreign Application Priority Data
May 24, 2013 (CN) 2013101966306

(51) Int. Cl. B25B 27/06

(52) U.S. Cl. CPC B25B 27/062
USPC 29/264

(57) ABSTRACT

A pin puller comprising a pull rod, a limiting member, and a supporting sleeve. The pull rod comprising a threaded portion, and the limiting member is screwed on the threaded portion. The supporting sleeve defining a receiving through hole, and the threaded portion movably passing through the receiving hole thereby the supporting sleeve can be movably sleeved on the threaded portion and limited by the limiting member. One end of the threaded portion can be received in the receiving hole defining a stepped hole. The pin puller further comprising a locking member, the locking member can be detachably latched into the stepped hole, and partially protruding from the threaded portion.

### FIELD

The present disclosure relates to a pin puller.

### BACKGROUND

Pin pullers are configured for disassembling cylindrical pins with internal thread. The pin puller includes a supporting sleeve, a limiting member and a pull rod. The supporting sleeve defines a locking hole threadedly engaged with the limiting member. The pull rod includes a guiding portion, a fixing portion and a threaded portion protruding out from two ends of the guiding portion. The guiding portion movably passes through the limiting member, the threaded portion is threadedly engaged with the cylindrical pin with internal thread, and a bearing is mounted between the limiting member and the limiting portion. When disassembling the cylindrical pin from the internal thread, one end of the threaded portion of the pull rod is threadedly engaged with the cylindrical pin and internal thread. The limiting member is rotated by a spanner, moving the pull rod with the limiting member relative to the supporting sleeve, and the cylindrical pin with internal thread moves with the pull rod to be disassembled from a workpiece. However, the threaded portion of the pull rod is easy worn in use. The whole pull rod needs to be replaced after the threaded portion is worn. When replacing the pull rod, the pull rod is pulled out from the limiting member, and the bearing is disassembled from the pull rod. Then, the bearing is mounted on a new pull rod, and the new pull rod movably passes through the limiting member. The process of replacing the pull rod is complex and costs a great deal of time.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is a perspective view of a pin puller in use according to a first embodiment of this disclosure.

FIG. 2 is an exploded perspective view of the pin puller as shown in FIG. 1.

FIG. 3 is a cross-sectional view of the pin puller taken along a line III-III as shown in FIG. 1.

FIG. 4 is a cross-sectional view of a pin puller according to a second embodiment of this disclosure.

### DETAILED DESCRIPTION

This disclosure is illustrated by way of example and not by way of limitation in the figures of the accompanying drawings in which like reference numbers indicate similar elements. It should be noted that references to “an” or “one” embodiment in this disclosure are not necessarily to the same embodiment, and such references mean “at least one”.

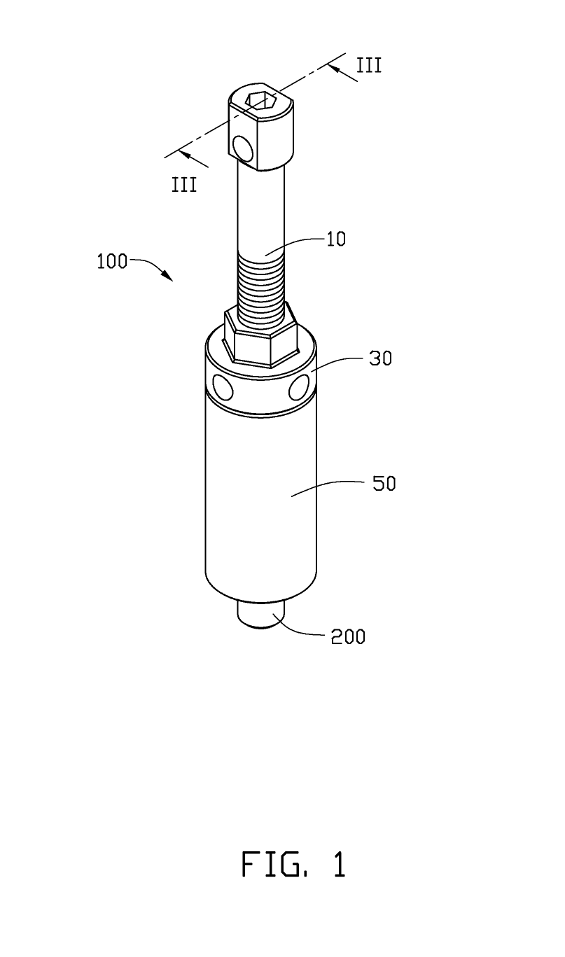

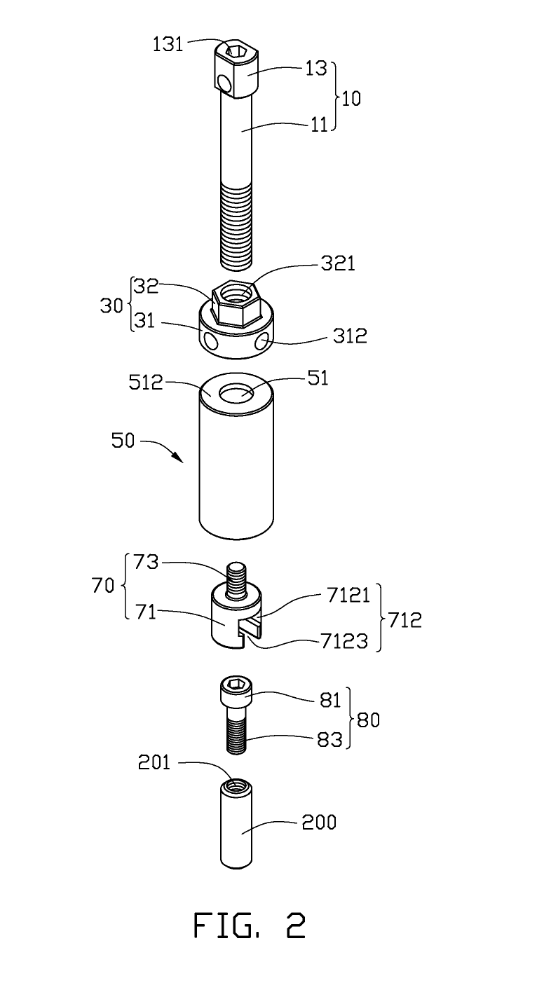

FIG. 1 and FIG. 2 show a pin puller 100 according to a first embodiment of this disclosure, which can be configured for removing a cylindrical pin with internal thread 200. The cylindrical pin with internal thread 200 can be configured for coupling two workpieces (not shown), defined with a threaded hole 201. The pin puller can include a pull rod 10, a limiting member 30, a supporting sleeve 50, a connecting member 70, and a locking member 80. Several definitions that apply throughout this disclosure will now be presented. The term “coupled” is defined as connected, whether directly or indirectly through intervening components, and is not necessarily limited to physical connections. The connection can be such that the objects are permanently connected or releasably connected.

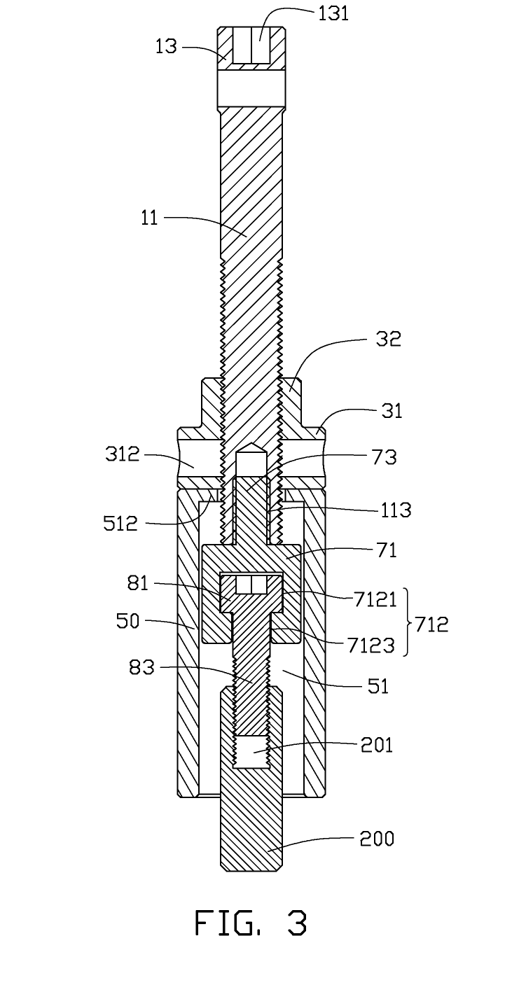

The pull rod 10 can be substantially shaped as a stepped cylinder and includes a threaded portion 11 and an anti-rotating portion 13 protruding out from one end of the threaded portion 11. The threaded portion 11 can be substantially cylindrical shaped, and the other end of the threaded portion 11 away from the anti-rotating portion 13 can define a fixing hole 113 (as shown in FIG. 3). One end of the anti-rotating portion 13 away from the threaded portion 11 can define an anti-rotating hole 131.

FIG. 3 shows a cross-sectional view of the pin puller taken along a line III-III of the pin puller 100 illustrated in FIG. 1. The limiting member 30 can be screwed on the threaded portion 11 of the pull rod 10, and can include an operating portion 31, and a threaded portion 32 protruding out from one end of the operating portion 31. The operating portion 31 and the threaded portion 32 can be arranged coaxially. The outer surface of the operating portion 31 can be provided with a plurality of operating holes 312 spaced from each other. The threaded portion 32 can define a threaded hole 321 passed through the operating portion 31. The threaded hole 321 can communicate with the plurality of operating holes 312. The threaded portion 11 of the pull rod 10 can be threaded in the threaded hole 321, enabling the limiting member 30 to be threadedly engaged with the pull rod 10.

The supporting sleeve 50 can be movably sleeved on the threaded portion 11 of the pull rod 10, and can be limited by the operating portion 31 of the limiting member 30. The supporting sleeve 50 can define a receiving through hole 51. One end of the supporting sleeve can extend toward the central portion of the receiving hole 51 to from a stopper portion 512. The threaded portion 11 of the pull rod 10 can be movably passed through the stopper portion 512 and the receiving hole 51, and can be received in the receiving hole 51. The stopper portion 512 can prevent the connecting member 70 from detaching from the supporting sleeve 50. The operating portion 31 of the limiting member 30 can be limited by the stopper portion 512.

The connecting member 70 can be removably installed into the fixing hole 113 and received in the receiving hole 51 of the supporting sleeve 50. The connecting member 70 can include a hanging portion 71 and a fixing portion 73 protruding out from one end of the hanging portion 71. The fixing portion 73 can be threaded into the fixing hole 113 of the threaded portion 11. The hanging portion 71 can be received in the receiving hole 51 and resisted against the end of the threaded portion away from the anti-rotating portion 11. The sidewall of the hanging portion 71 can define a T-shaped stepped hole 712. The stepped hole 712 can include a latching hole 7121 and a guiding hole 7123 vertically coupled with the guiding hole 7123. The width of the latching hole 7121 can be larger than the width of the guiding hole 7123. The guiding hole 7123 can extend to an end surface of the hanging portion 71 away from the fixing portion 73. The fixing portion 73 can be threaded into the fixing hole 113, enabling the fixing portion 73 to threadedly engage with the threaded portion 11.

The locking member 80 can be detachably latched in the stepped hole 712 of the connecting member 70, and partially protrude out of the connecting member 70. The locking member 80 can include a latching portion 81 and a locking portion 83 protruding from one end of the latching portion 81. The latching portion 81 can be detachably latched into the latching hole 7121 of the connecting member 70. The locking portion 83 can be received in the guiding hole 7123, and one end of the locking portion 83 away from the latching portion 81 can protrude out of the connecting member 70 through the guiding hole 7123 to lock the threaded hole 201 of the cylindrical pin with internal thread 200 when used. In this embodiment, the locking member 80 can be a socket head cap screw.

In use, the locking portion 83 of the locking member 80 can be locked in the threaded hole 201 of the cylindrical pin with internal thread 200. Then, the limiting member 30 and the supporting sleeve 50 can move to a position near the anti-rotating portion 13, thereby the connecting member 70 can extend out of the supporting sleeve 50. After that, the latching portion 81 can be latched in the latching hole 7121, and the locking portion 83 can be received in the guiding hole 7123. Then, the supporting sleeve can be released, and slide down to the workpiece by gravity. A first spanner (not shown) can be latched in the anti-rotating hole 131 to prevent the pull rod 10 from rotating with the limiting member 30. A second spanner (not shown) can be latched in the operation hole 312 of the limiting member 30. The limiting member 30 can be rotated, and move toward the supporting sleeve 50 along the threaded portion 11 of the pull rod 10. When the limiting member 30 resists against the stopper portion 512 of the supporting sleeve 50, the supporting sleeve 50 can be positioned between the workpiece and the limiting member 30. Finally, the limiting member 30 can be rotated continuously. As the stopper portion 512 prevents the limiting member 30 from moving forward, the threaded portion 11 of the pull rod 10 can move upward relative to the supporting sleeve 50 and can drive the connecting member 70 and the locking member 80 to move, thereby the cylindrical pin with internal thread 200 can be disassembled from the workpiece.

When disassembling the locking member 80, the first spanner can be latched into the anti-rotating hole 131 of the pull rod 10, thus the pull rod 10 does not rotate with the limiting member 30. Then, the second spanner can be latched into the operation hole 312 of the limiting member 30 to rotate the limiting member 30. The limiting member 30 can move away from the supporting sleeve 50 along the threaded portion 11 of the pull rod 10. Then, the supporting sleeve 50 can move to a position near the anti-rotating portion 13, thus the connecting member 70 can reach out of the supporting sleeve 50. After that, the locking portion 83 of the locking member 80 can be removed, thereby the latching portion 81 moves along the latching hole 7121, the locking portion 83 moves along the guiding hole 7123, and the locking member 80 can detached from the stepped hole 712. Finally, a latching portion 81 of a new locking member 80 can be latched into the latching hole 7121 of the connecting member 70, and the locking portion 83 can be received in the guiding hole 7123, whereby the locking member 80 can be replaced.

The pin puller 100 of this disclosure includes the pull rod 10, the limiting member 30, the sleeve portion 50, the connecting member 70, and the locking member 80. The limiting member 30 can be screwed on the threaded portion 11 of the pull rod 10, the supporting sleeve 50 can be movably sleeved on the threaded portion 11 of the pull rod 10, and can resist the operating portion 31 of the limiting member 30. The locking member 80 can be connected with the hanging portion 71 of the connecting member 70, and received in the receiving hole 51 of the supporting sleeve 50. Because the pull rod 10, the connecting member 70, and the locking member 80 can be independent, users can replace the locking member 80 without disassembling or replacing the pull rod 10 and the connecting member 70 when the locking member 80 is worn. Therefore, it is convenient to replace the locking member 80, and the time of replacing the locking member 80 can be reduced. It is understood that the fixing portion 73 and the threaded portion 11 can be connected by latching or welding.

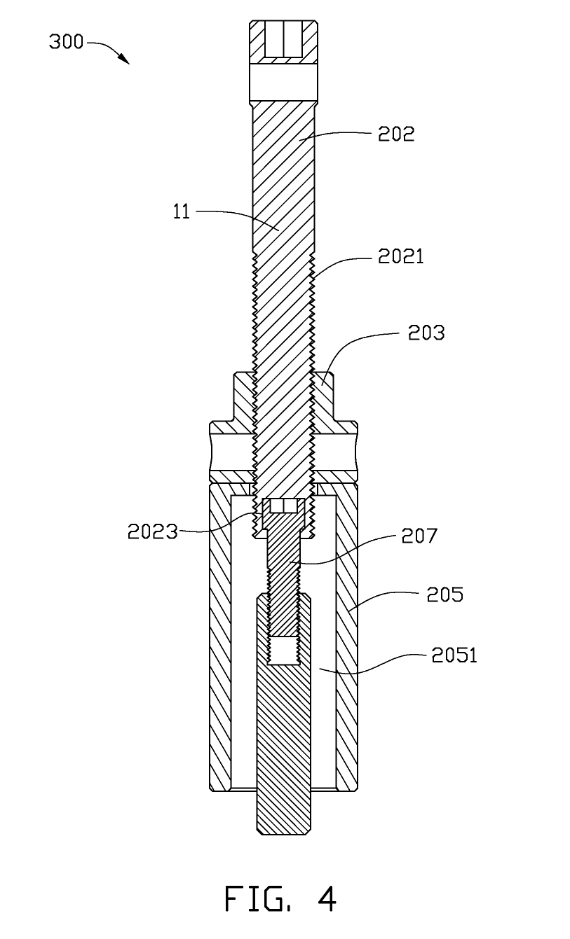

FIG. 4 shows a pin puller 300 according to a second embodiment of this disclosure. The pin puller 300 of the second embodiment, can be similar to the pin puller 100 of the first embodiment, and can include a pull rod 202, a limiting member 203, a supporting sleeve 205, and a locking member 207. However, one end of a threaded portion 2021 of the pull rod 202 can define a T-shaped stepped hole 2023 which takes the place of the connecting member 70 of the first embodiment. The locking member 207 can be detachably latched into the stepped hole 2023, and can partially protrude from the threaded portion 2021.

It is believed that the present embodiments and their advantages will be understood from the foregoing description, and it will be apparent that various changes can be made thereto without departing from the spirit and scope of the embodiments or sacrificing all of its material advantages.

What is claimed is:

1. A pin puller comprising:
a pull rod comprising a threaded portion;
a limiting member coupled to the threaded portion; and
a supporting sleeve defining a receiving hole through thereof;
wherein the threaded portion movably passes through the receiving hole thereby the supporting sleeve can be movably sleeved on the threaded portion and limited by the limiting member; one end of the threaded portion received in the receiving hole defines a stepped hole; the pin puller further comprises a locking member, the locking member is detachably latched into the stepped hole, and partially protrudes from the threaded portion.

2. The pin puller as claimed in claim 1, wherein one end of the supporting sleeve further comprises a stopper portion, the threaded portion of the pull rod movably passes through the stopper portion, and the limiting member resists against the stopper portion.

3. The pin puller as claimed in claim 1, wherein the stepped hole further comprises a latching hole and a guiding hole vertically communicated with the guiding hole, the locking member further comprises a latching portion and a locking portion protruding out of the latching portion, the latching portion is detachably latched into the latching hole, and one end of the locking portion away from the latching portion reaches out of the threaded portion through the guiding hole.

4. The pin puller as claimed in claim 1, wherein the limiting member further comprises an operating portion and a threaded portion protruding out of the operating portion, the threaded portion defines a threaded hole through thereof, and the threaded portion is threaded into the threaded hole.

5. The pin puller as claimed in claim 4, wherein the outer surface of the operating portion further defines a plurality of operating holes spaced with each other and communicated with the threaded hole.

6. The pin puller as claimed in claim 1, wherein the pull rod further comprises an anti-rotating portion protruding out of one end of the threaded portion, and one end of the anti-rotating portion away from the threaded portion defines an anti-rotating hole.

7. A pin puller comprising:
a pull rod comprising a threaded portion;
a limiting member screwed on the threaded portion, and
a supporting sleeve defining a receiving hole through thereof;
wherein the threaded portion movably passes through the receiving hole thereby the supporting sleeve can be movably sleeved on the threaded portion and resisted against the limiting member; the pin puller further comprises a connecting member and a locking member, the connecting member is fixedly connected with one end of the threaded portion received in the receiving hole, the connecting member defines a stepped hole, and the locking member is detachably latched into the stepped hole, and partially protrudes from the connecting member.

8. The pin puller as claimed in claim 7, wherein one end of the supporting sleeve defines a stopper portion, the threaded portion of the pull rod movably passes through the stopper portion, the limiting portion resists against the stopper portion, and the stopper portion prevents the connecting member detaching from the supporting sleeve.

9. The pin puller as claimed in claim 7, wherein one end of the threaded portion defines a fixing hole; the connecting member comprises a hanging portion and a fixing portion protruding out of one end of the hanging portion, the stepped hole is defined in the hanging portion, the fixing portion is threaded in the fixing hole of the threaded portion, the hanging portion is received in the receiving hole and resisted against one end of the threaded portion.

10. The pin puller as claimed in claim 7, wherein the stepped hole further comprises a latching hole and a guiding hole vertically communicated with the latching hole, the locking member comprises a latching portion and a locking portion protruding out of the latching portion; the latching portion is detachably latched into the latching hole, and one end of the locking portion reached out of the connecting member through the guiding hole.
